(19) United States
(12) Patent Application Publication
(10) Pub. No.: US 2014/0183125 A1
(43) Pub. Date: Jul. 3, 2014

(54) LIQUID ABSORBER, LIQUID ABSORPTION TANK, AND ELECTRICAL MACHINE

(71) Applicant: SEIKO EPSON CORPORATION, Tokyo (JP)

(72) Inventors: Toshiaki YAMAGAMI, Shiojiri, Nagano (JP); Shunichi SEKI, Suwa, Nagano (JP)

(73) Assignee: SEIKO EPSON CORPORATION, Tokyo (JP)

(21) Appl. No.: 14/132,944

(22) Filed: Dec. 18, 2013

(30) Foreign Application Priority Data
Dec. 27, 2012 (JP) 2012-284520
Dec. 27, 2012 (JP) 2012-284521

(51) Int. Cl. B01J 20/28; B01D 15/00

(52) U.S. Cl. CPC B01J 20/28023; B01D 15/00
USPC 210/435; 210/502.1

(57) ABSTRACT

To provide a liquid absorber having excellent permeability and retention properties, a liquid absorber is for absorbing a liquid, wherein the liquid absorber is principally made of a fiber and also includes additives having a greater critical surface tension than the critical surface tension of the fiber.

### CROSS-REFERENCE TO RELATED APPLICATIONS

This application claims priority to Japanese Patent Application No. 2012-284520 filed on Dec. 27, 2012 and Japanese Patent Application No. 2012-284521 filed on Dec. 27, 2012. The entire disclosure of Japanese Patent Application Nos. 2012-284520 and 2012-284521 is hereby incorporated herein by reference.

### BACKGROUND

1. Technical Field

The present invention relates to a liquid absorber, a liquid absorption tank, and an electrical machine.

2. Background Technology

Absorbers principally formed of a cellulose fiber have been known as examples of liquid absorbers for absorbing ink (see, for example, Patent Document 1).

Japanese Laid-open Patent Publication No. 2000-135797 (Patent Document 1) is an example of the related art.

### SUMMARY

### Problems to be Solved by the Invention

Patent Document 1 given above lacks satisfactory permeability with which the ink is permeated into the absorber, and therefore permeability has been ensured by also layering a bulk synthetic fiber sheet layer onto at least one side of a base material layer formed principally of a cellulose fiber. Nevertheless, the permeability in the base material layer remains unchanged in Patent Document 1, and the problem of the ink not permeating into the entirety of the base material layer has yet to be solved. In cases where a pigment ink is used, additionally, a problem has emerged in that pigment particles are deposited in the base material layer made principally of the cellulose fiber.

### Means Used to Solve the Above-Mentioned Problems

Having been created in order to resolve the above-mentioned problems at least in part, the invention can be implemented as the aspects and application examples described below.

### Application Example 1

A liquid absorber as in the present application example absorbs a liquid, the liquid absorber being characterized by being composed principally of a fiber and including an additive that has a greater critical surface tension than the critical surface tension of the fiber.

According to the configuration of such description, the liquid absorber is composed primarily of a fiber, and an additive having a greater critical surface tension than the critical surface tension of the fiber is included. This causes the additive to be present between the fibers, causes the portion thereof to be more readily wetted with respect to the liquid, and makes it possible to raise the permeability to the liquid overall. The action of the additive also makes it possible to raise the retention properties for retaining the absorbed liquid.

### Application Example 2

The liquid absorber as in the application example above, characterized in that the additive has a greater critical surface tension than the surface tension of the liquid.

According to the configuration of such description, applying an additive that has a greater critical surface tension than the surface tension of the liquid causes the liquid absorber to be even more readily wetted with respect to the liquid, and makes it possible to raise the permeability to the liquid.

### Application Example 3

The liquid absorber as in the application example above, characterized in that the critical surface tension of the additive is 1.5-fold or more the critical surface tension of the cellulose fiber.

According to the configuration of such description, the permeability can be further improved.

### Application Example 4

A liquid absorber as in the present application example absorbs a liquid, the liquid absorber being characterized by being composed principally of a cellulose fiber, and including an additive that is more highly hydrophobic than is the cellulose fiber.

According to the configuration of such description, the liquid absorber is composed principally of a cellulose fiber, and an additive more highly hydrophobic than the cellulose fiber is included. This causes the additive to be present between the cellulose fibers. As such, the hydrophobicity is higher than the cellulose fiber alone, and thus it is possible to improve the permeability to the liquid and also to raise the ability to retain the absorbed liquid.

### Application Example 5

The liquid absorber as in the application example above, characterized in that the liquid is waste ink that has been discharged from a head for ejecting ink.

According to the configuration of such description, it is possible to improve the permeability to waste ink serving as the liquid, and to raise the ability to retain the absorbed ink. “Waste ink” refers to ink that is discharged from the head and has not reached the medium. More specifically, “waste ink” refers to ink generated by flushing for ejecting out the ink for purposes such as preventing increasing of ink viscosity, or by cleaning for forcibly discharging the ink with a pump or the like with the purpose of preventing increasing the ink viscosity and restoring nozzles with which ejecting is no longer possible due to increasing of the ink viscosity, breaking of the meniscus, the effects of paper powder, or the like. In so-called borderless printing, some ink that has falling away from the medium does not reach the medium either and is thus included in waste ink.

### Application Example 6

The liquid absorber as in the application example above, characterized in that the ink is a pigment ink in which pigment particles are dispersed.

According to the configuration of such description, because the liquid absorber is more readily wetted with respect to the pigment ink, the permeability can be improved even for the pigment ink.

### Application Example 7

The liquid absorber as in the application example above, characterized in that the additive is a surface-modified cellulose fiber that has been surface-modified.

According to the configuration of such description, the surface-modified cellulose fiber serving as an additive is interposed in the liquid absorber, thereby improving the permeability to the liquid and also making it possible to raise the ability to retain the absorbed liquid.

### Application Example 8

A liquid absorption tank as in the present application example is characterized by being provided with the liquid absorber described above and an containing section for containing the liquid absorber.

According to the configuration of such description, containing the liquid absorber having permeability to the liquid and the ability to retain the liquid makes it possible to retain the absorbed liquid and preventing leakage and the like even in a case where, for example, the liquid absorption tank is arranged at an angle or sideways.

### Application Example 9

An electrical machine as in the present application example is characterized by being provided with a discharge unit for discharging a liquid, and the liquid absorption tank described above for capturing the discharged liquid.

According to the configuration of such description, it is possible to provide a more highly reliable electrical machine that efficiently absorbs the liquid without the occurrence of problems such as leakage of the liquid. Examples that could be applied as the electrical machine include electrical machines where a variety of liquids are used, such as an inkjet printer provided with a head for ejecting an ink serving as the liquid.

### BRIEF DESCRIPTION OF THE DRAWINGS

Referring now to the attached drawings which form a part of this original disclosure:

FIG. 1 is a schematic view illustrating a configuration of a liquid absorber;

FIG. 2 is a schematic view illustrating a configuration of a liquid absorption tank;

FIG. 3 is a schematic view illustrating a configuration of a liquid absorber according to a second embodiment;

FIG. 4 is a schematic view illustrating a configuration of a liquid absorption tank according to a second embodiment;

FIG. 5 is a schematic view illustrating a configuration of an electrical machine; and

FIGS. 6A and 6B are schematic views illustrating methods for assessing the ability of a liquid absorber to be permeated by ink and to retain ink.

### DETAILED DESCRIPTION OF EXEMPLARY EMBODIMENTS

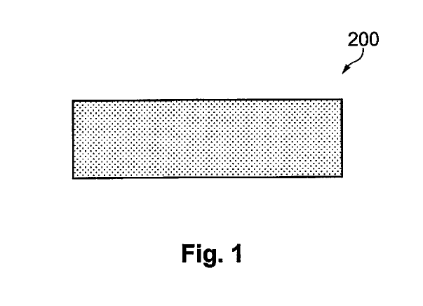

A first and second embodiment of the invention shall be described below with reference to accompanying FIGS. 1 to 4. In each of the drawings given below, the scale of the respective members and the like has been illustrated differently from the actual scale, in order to increase the size of the respective members and the like to such an extent as to be visually recognizable.

### First Embodiment

First, the configuration of the liquid absorber shall be described. FIG. 1 is a schematic view illustrating the configuration of the liquid absorber. A cuboid liquid absorber 200 illustrated in FIG. 1 is for absorbing a liquid and is constituted principally of a cellulose fiber serving as a fiber. Other than the cellulose fiber, the liquid absorber 200 as in the present embodiment also includes a thermoplastic resin and a flame retardant as well as an additive of a greater critical surface tension than the critical surface tension of the cellulose fiber.

The cellulose fiber of the present embodiment is obtained, for example, by using a dry defibration machine such as, for example, a rotary crusher device to defibrate a bleached pulp sheet. As such, a cellulose fiber of high purity is formed. The thermoplastic resin is for binding cellulose fibers to each other to retain a strength (hardness or the like) that is suitable for the liquid absorber 200, preventing scattering of the paper powder or fiber, contributing to shape retention for when the liquid has been absorbed, and so forth. A variety of forms of thermoplastic resin, such as fibrous or powdery thermoplastic resins, can be employed. Heating the mixture obtained by mixing the cellulose fiber and the thermoplastic resin makes it possible to cause the thermoplastic resin to melt, thus causing the thermoplastic resin to be fused and fixed to the cellulose fiber. Preferably, the fusing is carried out at a temperature low enough to not thermally degrade the cellulose fiber and the like. It is also preferable for the thermoplastic resin to be fibrous, becoming more readily entangled with the paper fiber in the defibrated product. Also preferable is a composite fiber of a core-sheath structure. With a thermoplastic resin of a core-sheath structure, the surrounding sheath section melts at a lower temperature and the fibrous core section bonds either to the thermoplastic resin itself or to the cellulose fiber, thereby making possible to carry out a strong bonding.

The flame retardant is added in order to impart flame retardancy to the liquid absorber 200. Examples that can be used as the flame retardant include inorganic materials such as aluminum hydroxide and magnesium hydroxide, and phosphorus-based organic materials (for example, aromatic phosphoric acid esters such as triphenyl phosphate).

Additives applied are those having a greater critical surface tension than the critical surface tension of the cellulose fiber. It is possible to apply an additive having a critical surface tension greater than the surface tension of the liquid. More specifically, an additive can be applied provided that the critical surface tension is 70 to 400 mN/m. Examples that can be applied as additives include calcium carbonate, silica, iron oxide, soda glass, and the like. Additives could also be selected as appropriate depending on the liquid that is intended to be handled. That is to say, it is preferable to add an additive that has a critical surface tension greater than the surface tension of the liquid being absorbed. For example, in a case where the surface tension of an ink serving as the liquid is 20 to 40 mN/m and the critical surface tension of the cellulose fiber is 46 mN/m, then there is merely a slight difference between the critical surface tensions of the ink and the cellulose fiber, and the permeability to the ink is comparatively low. Therefore, additives for which the critical surface tension is 1.5-fold or more that of the cellulose fiber are applied. In such a case, for example, calcium carbonate is preferable. This causes the difference in critical surface tension between the ink and the additives (for example, calcium carbonate) present between the cellulose fibers to increase in the positive direction, and makes it possible to further improve the permeability to the ink. As additional selections as additives, for example, in a case where the liquid is dripped onto the liquid absorber 200, then an additive can be selected so that the contact angle in relation to the surface of the liquid absorber 200 is substantially zero, i.e., so as to have a critical surface tension with which the liquid will spread. In so doing, the permeability to the liquid can be further increased. The size of the additive should allow capillary action to take place, mainly from sizes allowing entry between the cellulose fibers to sizes preventing spilling over and falling out. With sizes equivalent to the cellulose fiber diameter, it is also more preferable not to twist the cellulose fiber out of shape.

One example of a method for forming the liquid absorber 200 includes sifting a mixture of the cellulose fiber, the thermoplastic resin, the flame retardant, and the additive, and depositing same onto a mesh belt arranged below the sifter to form a deposit. The deposited matter thus formed is then treated by heating and pressurization. This causes the thermoplastic resin to be dissolved and causes a desired thickness to be formed. Cutting out to the desired dimensions causes the liquid absorber 200 to be formed.

The additive is uniformly dispersed through the liquid absorber 200 formed in this manner, thus making it possible for permeability to be evenly exhibited throughout the entire liquid absorber.

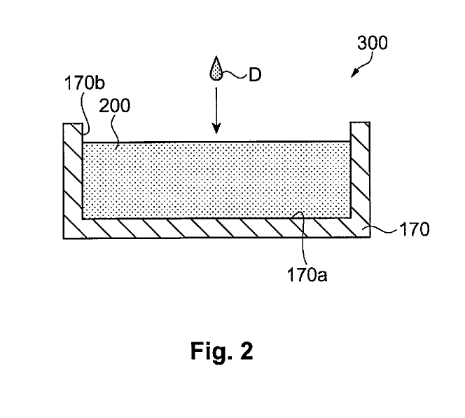

The configuration of a liquid absorption tank shall be described next. FIG. 2 is a cross-sectional view illustrating the configuration of a liquid absorption tank. As illustrated in FIG. 2, a liquid absorption tank 300 is provided with the liquid absorber 200 for absorbing a liquid and an containing section 170 for containing the liquid absorber 200.

The liquid absorber 200 is made principally of the cellulose fiber, and also includes an additive having a critical surface tension greater than the critical surface tension of the cellulose fiber. The more detailed configuration of the liquid absorber 200 is similar to the configuration in FIG. 1, and thus a description is herein omitted.

The containing section 170 for containing the liquid absorber 200 is formed to have a cuboid shape of, for example, a plastic material. The containing section 170 is provided with a bottom surface section 170a and a side surface section 170b, and is formed so as to be able to accommodate and also retain the liquid absorber 200.

When, for, example, as illustrated in FIG. 2, a droplet D of the liquid is discharged toward the liquid absorber 200 and arrives at the surface of the liquid absorber 200, then because the liquid absorber 200 has a greater critical surface tension than that of the droplet D (the liquid), the droplet D is swiftly permeated into the interior. The absorbed liquid is then retained by the action of the additive and the like.

The liquid absorption tank 300 can also be a configuration in which a plurality of liquid absorbers 200 are layered. The number of liquid absorbers 200 that are layered can be set as appropriate. According to the configuration of such description, it is possible to increase the capacity for absorbing the liquid.

### Second Embodiment

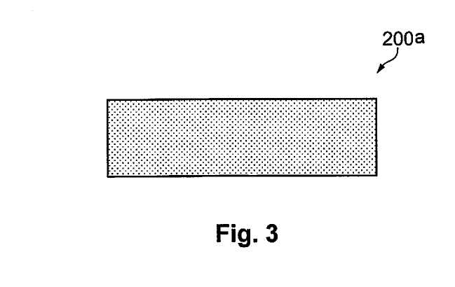

The configuration of a liquid absorber of a second embodiment shall be described next. FIG. 3 is a schematic view illustrating the configuration of the liquid absorber. A cuboid liquid absorber 200a illustrated in FIG. 3 is for absorbing a liquid, and is constituted principally of a cellulose fiber. In addition to the cellulose fiber, the liquid absorber 200a as in the present embodiment includes the thermoplastic resin and the flame retardant, as well as an additive that is more hydrophobic than is the cellulose fiber.

The cellulose fiber of the present embodiment is obtained, for example, by using a dry defibration machine such as, for example, a rotary crusher device to defibrate a pulp sheet. The thermoplastic resin is for binding cellulose fibers to each other to retain a strength (hardness or the like) that is suitable for the liquid absorber 200a, preventing scattering of the paper powder or fiber, contributing to shape retention for when the liquid has been absorbed, and so forth. A variety of forms of thermoplastic resin, such as fibrous or powdery thermoplastic resins, can be employed. Heating the mixture obtained by mixing the cellulose fiber and the thermoplastic resin makes it possible to cause the thermoplastic resin to melt, thus causing the thermoplastic resin to be fused and fixed to the cellulose fiber. Preferably, the fusing is carried out at a temperature low enough to not thermally degrade the cellulose fiber and the like. It is also preferable for the thermoplastic resin to be fibrous, becoming more readily entangled with the paper fiber in the defibrated product. Also preferable is a composite fiber of a core-sheath structure. With a thermoplastic resin of a core-sheath structure, the surrounding sheath section melts at a lower temperature and the fibrous core section bonds either to the thermoplastic resin itself or to the cellulose fiber, thereby making possible to carry out a strong bonding.

The flame retardant is added in order to impart flame retardancy to the liquid absorber 200a. Examples that can be used as the flame retardant include inorganic materials such as aluminum hydroxide and magnesium hydroxide, and phosphorus-based organic materials (for example, aromatic phosphoric acid esters such as triphenyl phosphate).

Additives applied are those that are more hydrophobic than is the cellulose fiber. As an additive, it would be possible to apply a surface-modified cellulose fiber that has been hydrophobically surface-modified. Forms of surface modification include modifiers such as phthalic acid-based polyesters, non-ionic surfactants with a polyethylene glycol group, a variety of metallic soaps, and the like that react readily with cellulose, among which silane coupling agents, which enable firm modification, are preferable. Silane coupling agents available for use would include one species, or a combination of two species or more, in which one or two functional groups or two or three hydrolyzable groups and zero or one non-reactive group are bonded to a silicon atom. Preferable among these are silane coupling agents that have a high hydrophobic hydrocarbon chain or silane coupling agents that have a highly reactive amino group. More preferable are hexyltrimethoxysilane, butyltrimethoxysilane, 3-aminopropyl trimethoxysilane, 3-aminopropyl triethoxysilane, 3-aminopropyl methyldimethoxysilane, 3-aminopropyl methyldiethoxysilane, 2-aminoethyl-3-aminopropyl trimethoxysilane, 2-aminoethyl-3-aminopropyl triethoxysilane, 2-aminoethyl-3-aminopropyl methyldimethoxysilane, 2-aminoethyl-3-aminopropyl methyldiethoxysilane, 3-[2-(2-aminoethylamino) ethylamino]propyl trimethoxysilane, and 3-[2-(2-aminoethylamino) ethylamino]propyl triethoxysilane. Surface modification includes carrying out a surface treatment with the following procedure. First, a silane coupling agent, methanol, ethanol or another lower alcohol, and water are mixed together to partially hydrolyze the silane coupling agent. Next, a cellulose fiber is brought into contact with this solution, following which the solvent is slowly dried, thus making it possible for the cellulose surface to be modified by the silane coupling agent.

Adding the surface-modified cellulose fiber increases the hydrophobicity in comparison to cellulose fiber alone, and thus makes it possible to improve the permeability to the liquid as well as to raise the ability to retain the absorbed liquid. Examples that can be applied as the liquid would include waste ink that has been discharged from a head for ejecting ink. Having the ink be a pigment ink in which pigment particles are dispersed would also make it possible to further improve the permeability and retention performance. Pigment inks contain a greater resin component in order for the pigment particles, which are larger than a dye, to be dispersed and fixed, and there is a tendency for pigment particles to be relatively hydrophobic. As such, an absorber, too, to which a more highly hydrophobic component has been added will have a higher affinity to the pigment particles, thus making it possible to improve the permeability performance.

One example of a method for forming the liquid absorber 200 includes sifting a mixture of the cellulose fiber, the thermoplastic resin, the flame retardant, and the additive, and depositing same onto a mesh belt arranged below the sifter to form a deposit. The deposited matter thus formed is then treated by heating and pressurization. This causes the thermoplastic resin to be dissolved and causes a desired thickness to be formed. Cutting out to the desired dimensions causes the liquid absorber 200a to be formed.

The liquid absorber 200a thus formed is more highly hydrophobic and thus allows for the liquid to more readily (rapidly) be permeated. The additive also makes it possible to raise the retention properties for retaining the absorbed liquid.

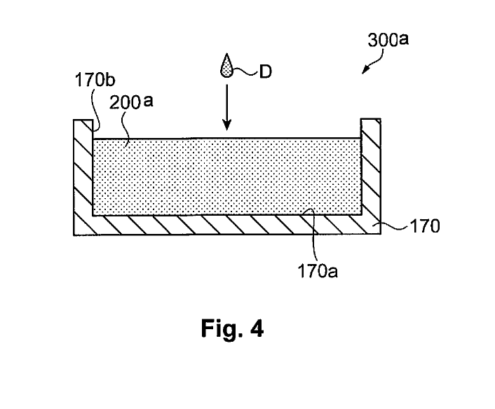

The configuration of a liquid absorption tank shall be described next. FIG. 4 is a cross-sectional view illustrating the configuration of a liquid absorption tank. As illustrated in FIG. 4, a liquid absorption tank 300a is provided with the liquid absorber 200a for absorbing the liquid and the containing section 170 for containing the liquid absorber 200a.

The liquid absorber 200a is made principally of the cellulose fiber, and also includes an additive that is more highly hydrophobic than is the cellulose fiber. The more detailed configuration of the liquid absorber 200a is similar to the configuration in FIG. 3, and thus a description is herein omitted.

The containing section 170 for containing the liquid absorber 200a is formed to have a cuboid shape of, for example, a plastic material. The containing section 170 is provided with a bottom surface section 170a and a side surface section 170b, and is formed so as to be able to accommodate and also retain the liquid absorber 200a.

When, for, example, as illustrated in FIG. 4, a droplet D of the liquid is discharged toward the liquid absorber 200a and arrives at the surface of the liquid absorber 200a, then because the liquid absorber 200a is very hydrophobic, the liquid is swiftly permeated into the interior. The absorbed liquid is then retained by the action of the additive and the like.

The liquid absorption tank 300a can be of a configuration where a plurality of the liquid absorbers 200a are layered. The number of liquid absorbers 200a that are layered can be set as appropriate. According to the configuration of such description, it is possible to increase the capacity for absorbing the liquid.

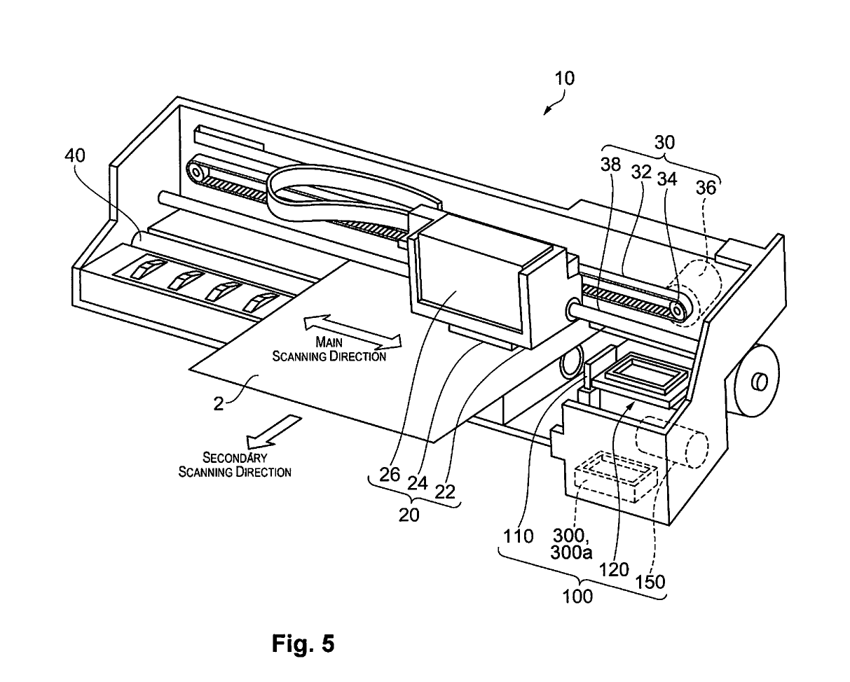

The configuration of an electrical machine shall be described next. The electrical machine is provided with a discharge unit for discharging a liquid and a liquid absorption tank for capturing the discharged liquid. FIG. 5 is a schematic view illustrating the configuration of the electrical machine. The present embodiment describes the configuration of an inkjet printer serving as the electrical machine. As illustrated in FIG. 5, an inkjet printer 10 is provided with: a head, serving as a discharge unit, for discharging an ink, serving as the liquid; and a liquid absorption tank for capturing the discharged ink (waste ink). The inkjet printer 10 of the present embodiment describes a configuration that is provided with an liquid absorption tank (300a) in which the liquid absorber 200 (200a) is accommodated.

The inkjet printer 10 is constituted of: a carriage 20 for forming ink dots on a print medium 2, such as print paper, while reciprocatingly moving in a main scanning direction; a drive mechanism 30 for reciprocatingly moving the carriage 20; a platen roller 40 for feeding out the print medium 2; a maintenance mechanism 100 for carrying out a maintenance so that printing can be done correctly; and the like. Provided to the carriage 20 are: an ink cartridge 26 that holds an ink; a carriage case 22 onto which the ink cartridge 26 is mounted; a head 24 for ejecting (discharging) the ink, which has been mounted onto a bottom surface side of the carriage case 22 (the side that faces the print medium); and the like. A plurality of nozzles for ejecting the ink are formed on the head 24, and an image is printed by guiding the ink that is inside the ink cartridge 26 to the head 24 and ejecting an exact amount of the ink onto the print medium 2 from the nozzles.

The drive mechanism 30 for reciprocatingly moving the carriage 20 is constituted of: a guide rail 38 provided extending in the main scanning direction; a timing belt 32 on the inside of which a plurality of tooth marks are formed; a drive pull 34 for meshed engagement with the tooth marks of the timing belt 32; a step motor 36 for driving the drive pulley 34; and the like. A part of the timing belt 32 is fixed to the carriage case 22, and driving the timing belt makes it possible to move the carriage case 22 along the guide rail 38. Also, because the tooth marks create a meshed engagement between the timing belt 32 and the drive pulley 34, when the drive pulley 34 is driven with the step motor 36, then it becomes possible to move the carriage case 22 precisely in accordance with the amount of driving.

The platen roller 40 for feeding out the print medium 2 is driven by a drive motor or gear mechanism (not shown), and is able to feed out predetermined increments of the print medium 2 in a secondary scanning direction.

The maintenance mechanism 100 is provided to a region that is called the home position, outside the print region, and is provided with a wiper blade 110 for wiping the surface (nozzle surface) on which the ejection nozzles are formed on the bottom surface side of the head 24, a cap unit 120 that is pressed against the nozzle surface of the head 24 and caps the head 24; and a suction pump 150 for discharging the ink as waste ink by being driven in a state where the head 24 has been capped with the cap unit 120. Forcibly discharging the ink from the head 24 with the suction pump 150 restores nozzles which are not longer able to eject due to increasing of the ink viscosity, destruction of the meniscus, the effects of paper dust, or the like, and prevents increasing the ink viscosity of the ink inside the nozzles. The liquid absorption tank 300 (300a) for capturing the waste ink that has been discharged from the suction pump 150 is further provided below the suction pump 150. Being provided with the liquid absorption tank 300 causes the external shape of the inkjet printer 10 to be larger. Improving the ink permeability and retention performance of the liquid absorber 200 makes it possible to reduce the volume of the liquid absorber 200 still able to retain the same amount of ink. This also reduces the size of the liquid absorption tank 300 and the inkjet printer 10. The liquid absorption tank 300 is similar to the configuration described in FIG. 2, and a description is thus herein omitted. Waste ink that has been discharged also encompasses any ink that does not reach the medium, such as ink created by a flushing for ejecting the ink with the purpose of preventing increasing of the ink viscosity or the like, or ink that falls away from the medium in so-called borderless printing. For this reason, the ink need not necessarily be ink that has been discharged with the suction pump 150. “Waste ink” refers to ink that is discharged from the head and has not reached the medium.

According to the present embodiments above, the following effects can be obtained.

(1) The liquid absorber 200 includes an additive that has a higher critical surface tension than the surface tension of the liquid (for example, ink). For this reason, the liquid absorber 200 will have a critical surface tension that is even higher than the critical surface tension in the cellulose fiber alone, thus making it possible to improve the permeability to the ink. The additive also makes it possible to retain the absorbed liquid. As such, it is possible to provide the liquid absorber 200 provided with permeability and retention performance.

(2) The liquid absorber 200a includes a surface-modified cellulose fiber serving as an additive that is more highly hydrophobic than is the cellulose fiber. For this reason, the liquid absorber 200a will be even more highly hydrophobic than the hydrophobicity in the cellulose fiber alone, thus making it possible to improve the permeability to the liquid. The additive also makes it possible to retain the absorbed liquid. As such, it is possible to provide the liquid absorber 200a provided with permeability and retention performance.

(3) With the liquid absorption tank 300 provided with the liquid absorber 200, the absorbed liquid (for example, ink) can be retained and leakage or the like can be prevented even in a case where the liquid absorption tank 300 is arranged at an angle or sideways.

(4) With the inkjet printer provided with the liquid absorption tank 300, it is possible to more effectively permeate the waste ink that has been discharged from the head 24, as well as to prevent the occurrence of problems such as leaking of the ink, and thus to ensure reliability.

### EXAMPLES

Specific examples as in the invention shall be described next.

### 1. Mixture

### (1) Cellulose Fiber

A previously bleached pulp sheet that was cut to several centimeters using a cutting machine was defibrated to a cotton-like form with a turbo mill (made by Turbo Industries Co., Ltd.).

### (2) Thermoplastic Resin

The thermoplastic resin was a 1.7-dtex thermoplastic fiber (TETRON, made by Teijin Co., Ltd.) that has a core-sheath structure, with a sheath that is polyethylene that melts at 100° C. and higher, and a core that includes polyester.

### (3) Flame Retardant

Aluminum hydroxide B53 (made by Nippon Light Metal Company Co., Ltd.)

### (4) Additives

(4-1) Silica: mean grain size 2.6 μm (NIPGEL AZ-200, made by Tosoh Silica Corp.)

(4-2) Silica: mean grain size 6.6 μm (NIPGEL AY-603, made by Tosoh Silica Corp.)

(4-3) Calcium carbonate: mean grain size 2.4 μm (Cal-light KT, made by Shiraishi Co., Ltd.)

(4-4) Calcium carbonate: mean grain size 3.1 μm (Cal-light SA, made by Shiraishi Co., Ltd.)

(4-5) Crushed iron oxide: mean grain size 4.5 μm

(4-6) Crushed soda glass: mean grain size 5.0 μm

(4-7) Silica slurry: (AZ-200, made by Tosoh Silica Corp.)

(4-8) Calcium carbonate slurry: (Vakofil 900, made by Shiraishi Calcium Co., Ltd.)

The mean grain sizes of each of the additives above are D50 values that were measured with Sysmex's FPIA 2000.

(4-9) Surface-modified cellulose fiber

A pulp sheet that was cut to several centimeters using a cutting machine was defibrated to a cotton-like form with a turbo mill (made by Turbo Industries Co., Ltd.). The defibrated cellulose fiber was surface-modified to form a surface-modified cellulose fiber that is hydrophobic. More specifically, the OH groups of the defibrated cellulose fiber were modified with a silane coupling agent (hexyltrimethoxysilane) to impart hydrophobicity. The degree of hydrophobicization of the surface-modified cellulose fiber was then confirmed. More specifically, the surface-modified cellulose fiber was placed in water and uniformly suspended, then the suspended solution was dripped onto a slide glass. The moisture was then removed to form a fiber film. Very small water droplets were then dropped onto the fiber film to measure the contact angle. As a result, it was found that the contact angle was 90° or higher, thus showing this surface-modified cellulose fiber to be highly hydrophobic.

### 2. Formation of the Liquid Absorber

### Example 1: Formation of a Liquid Absorber A

100 parts by weight of the cellulose fiber, 30 parts by weight of the thermoplastic resin, 10 parts by weight of the flame retardant, and 10 parts by weight of an additive (4-1 given above) were mixed together in air, and the resulting mixture was passed through a sifter and deposited onto a mesh belt. The deposited matter thus deposited was treated by pressurization and heating at 200° C. Thereafter, the treated matter was cut to 150 mm×50 mm×12 mm to form a liquid absorber A.

### Example 2

### Formation of a Liquid Absorber B

100 parts by weight of the cellulose fiber, 40 parts by weight of the thermoplastic resin, 10 parts by weight of the flame retardant, and 20 parts by weight of an additive (4-2 given above) were mixed together in air, and the resulting mixture was passed through a sieve and deposited onto a mesh belt. The deposited matter thus deposited was treated by pressurization and heating at 200° C. Thereafter, the treated matter was cut to 150 mm×50 mm×12 mm to form a liquid absorber B.

### Example 3

### Formation of a Liquid Absorber C

100 parts by weight of the cellulose fiber, 30 parts by weight of the thermoplastic resin, 10 parts by weight of the flame retardant, and 20 parts by weight of an additive (4-3 given above) were mixed together in air, and the resulting mixture was passed through a sieve and deposited onto a mesh belt. The deposited matter thus deposited was treated by pressurization and heating at 200° C. Thereafter, the treated matter was cut to 150 mm×50 mm×12 mm to form a liquid absorber C.

### Example 4

### Formation of a Liquid Absorber D

00 parts by weight of the cellulose fiber, 40 parts by weight of the thermoplastic resin, 10 parts by weight of the flame retardant, and 20 parts by weight of an additive (4-4 given above) were mixed together in air, and the resulting mixture was passed through a sieve and deposited onto a mesh belt. The deposited matter thus deposited was treated by pressurization and heating at 200° C. Thereafter, the treated matter was cut to 150 mm×50 mm×12 mm to form a liquid absorber D.

### Example 5

### Formation of a Liquid Absorber E

100 parts by weight of the cellulose fiber, 30 parts by weight of the thermoplastic resin, 10 parts by weight of the flame retardant, and 10 parts by weight of an additive (4-5 given above) were mixed together in air, and the resulting mixture was passed through a sifter and deposited onto a mesh belt. The deposited matter thus deposited was treated by pressurization and heating at 200° C. Thereafter, the treated matter was cut to 150 mm×50 mm×12 mm to form a liquid absorber E.

### Example 6

### Formation of a Liquid Absorber F

100 parts by weight of the cellulose fiber, 30 parts by weight of the thermoplastic resin, 10 parts by weight of the flame retardant, and 10 parts by weight of an additive (4-6 given above) were mixed together in air, and the resulting mixture was passed through a sifter and deposited onto a mesh belt. The deposited matter thus deposited was treated by pressurization and heating at 200° C. Thereafter, the treated matter was cut to 150 mm×50 mm×12 mm to form a liquid absorber F.

### Example 7

### Formation of a Liquid Absorber G

A bleached pulp sheet was coated with an additive (4-7 given above), and the resulting coated matter was dried. Thereafter, the dried matter was defibrated to a cotton-like form with a turbo mill (made by Turbo Industries Co., Ltd.) to form a defibrated matter including 100 parts by weight of the cellulose fiber and 25 parts by weight of an additive (4-7 given above). The additive was crushed until the size was a mean grain size of 5.8 μm (according to electron microscopy). Then, this defibrated matter was mixed in air together with 30 parts by weight of the thermoplastic resin and 10 parts by weight of the flame retardant; the resulting mixture was passed through a sifter and deposited onto a mesh belt. The deposited matter thus deposited was treated by pressurization and heating at 200° C. Thereafter, the treated matter was cut to 150 mm×50 mm×12 mm to form a liquid absorber G.

### Example 8

### Formation of a Liquid Absorber H

A bleached pulp sheet was coated with an additive (4-8 given above), and the resulting coated matter was dried. Thereafter, the dried matter was defibrated to a cotton-like form with a turbo mill (made by Turbo Industries Co., Ltd.) to form a defibrated matter including 100 parts by weight of the cellulose fiber and 25 parts by weight of an additive (4-8 given above). The additive was crushed until the size was a mean grain size of 9.9 μm (according to electron microscopy). Then, this defibrated matter was mixed in air together with 30 parts by weight of the thermoplastic resin and 10 parts by weight of the flame retardant; the resulting mixture was passed through a sifter and deposited onto a mesh belt. The deposited matter thus deposited was treated by pressurization and heating at 200° C. Thereafter, the treated matter was cut to 150 mm×50 mm×12 mm to form a liquid absorber H.

### Example 9

### Formation of a Liquid Absorber I

80 parts by weight of the cellulose fiber, 15 parts by weight of the thermoplastic resin, 15 parts by weight of the flame retardant, and 20 parts by weight of the surface-modified cellulose fiber were mixed together in air, and the resulting mixture was passed through a sifter and deposited onto a mesh belt. The deposited matter thus deposited was treated by pressurization and heating at 200° C. Thereafter, the treated matter was cut to 150 mm×50 mm×12 mm to form a liquid absorber I.

### Comparative Example 1

### Formation of a Liquid Absorber R

100 parts by weight of the cellulose fiber, 30 parts by weight of the thermoplastic resin, and 10 parts by weight of the flame retardant were mixed together in air, and the resulting mixture was passed through a sifter and deposited onto a mesh belt. The deposited matter thus deposited was treated by pressurization and heating at 200° C. Thereafter, the treated matter was cut to 150 mm×50 mm×12 mm to form a liquid absorber R. That is to say, a liquid absorber R that includes no additive was formed.

### Comparative Example 2

### Formation of a Liquid Absorber R′

100 parts by weight of the cellulose fiber, 15 parts by weight of the thermoplastic resin, and 5 parts by weight of the flame retardant were mixed together in air, and the resulting mixture was passed through a sifter and deposited onto a mesh belt. The deposited matter thus deposited was treated by pressurization and heating at 200° C. Thereafter, the treated matter was cut to 150 mm×50 mm×12 mm to form a liquid absorber R′. That is to say, a liquid absorber R′ that includes no surface-modified cellulose fiber was formed.

### 3. Assessment

Next, the ink permeability, the ink retention, and the ink deposition were assessed with the examples 1 to 9 and the comparative examples 1 and 2. Each of the methods of assessment are as follows.

### (a) Method for Assess Ink Permeability and Ink Retention

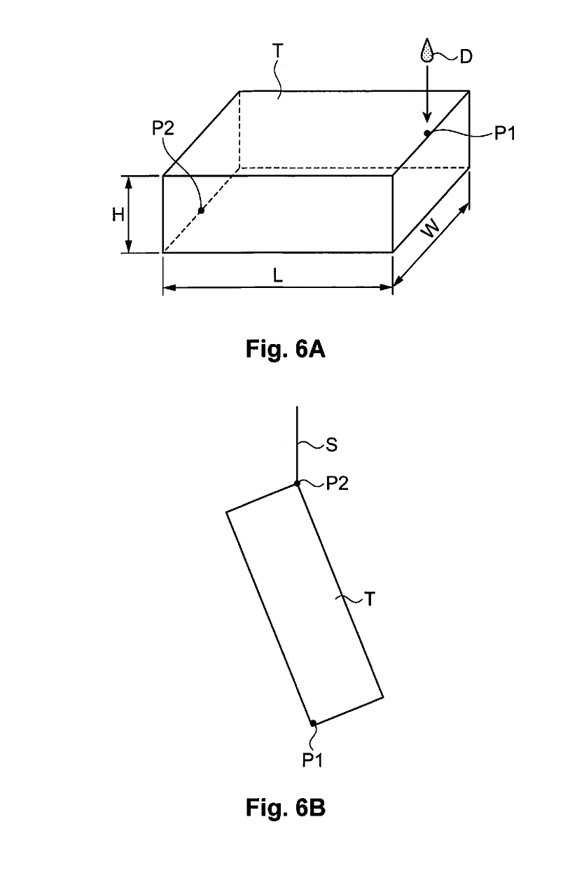

FIGS. 6A and 6B are schematic views illustrating a method for assessing the ability of a liquid absorber to be permeated by ink and to retain ink. As illustrated in FIG. 6A, a liquid absorber T that is 150 mm (L)×50 mm (W)×12 mm (H) was placed on a flat surface and 80 mL of ink, serving as the liquid droplets D, were slowly poured from a first point P1 of an upper surface. In a case where the ink did not soak into the absorber T, then the ink was allowed to stand for five minutes, following which the pouring was continued. In a case where five minutes of allowing the ink to stand still did not result in the ink soaking in, then the ink was regarded as having not permeated, and the ink permeability was determined to be NG. In a case where all the ink was successfully poured, then the ink permeability was determined to be OK. Once all of the ink was successfully poured, the liquid absorber was allowed to stand for five minutes, and, as illustrated in FIG. 6B, was suspended using a strap S or the like from a second point P2 so that the first point P1 from which the ink was poured became lower. In this suspended state, the permeated ink collected at one end of the liquid absorber T and became less readily retained. In a case where the ink dropped from the liquid absorber T, then the ink was regarded as having not been successfully retained, and the ink retention was determined to be NG. In a case where no ink dropped, however, the ink retention was determined to be OK. In a case where the ink permeability was determined to be NG, then the ink retention was not assessed, because the desired amount of ink could not have been absorbed. This assessment showed that the ink would not leak out even when the liquid absorption tank or an electrical machine for which a liquid is handled, such as an inkjet printer, is inclined.

### (b) Method for Assessing Ink Deposition

A liquid absorber T that is 150 mm (L)×50 mm (W)×12 mm (H) was placed on a flat surface and, in an environment at 40° C. and 20% RH, ink was dripped for one hour at 0.4 g increments onto a middle section of the upper surface of the liquid absorber T placed there. Then, after 240 hours, the ink deposition was determined to be OK when the thickness of solid deposited matter was less than 1 mm on the surface of the liquid absorber T. The ink deposition was determined to be NG when the thickness of deposited matter was 1 mm or more.

The ink permeability, ink retention, and ink deposition were assessed with respect to the examples and comparative examples given above. The results of assessment are as in table 1. The ink was a pigment ink.

TABLE 1

| | Ink Permeability | Ink Retention | Ink Deposition |
|---|---|---|---|
| Example 1 | OK | OK | OK |
| Example 2 | OK | OK | OK |
| Example 3 | OK | OK | OK |
| Example 4 | OK | OK | OK |
| Example 5 | OK | OK | OK |
| Example 6 | OK | OK | OK |
| Example 7 | OK | OK | OK |
| Example 8 | OK | OK | OK |
| Comparative | NG | — | NG |
| Example 1 | | | |

As illustrated in table 1, according to the liquid absorbers A to H (example 1 to 8) in the invention, the ink permeability, ink retention, and ink deposition were all assessed as being excellent. Comparative example 1, however, failed to yield satisfactory results. This is because the liquid absorbers A to H as in the examples 1 to 8 included the additives having a greater critical surface tension than the critical surface tension of the cellulose and than the surface tension of the ink, and thus the ink permeability was higher and the retention performance was more favorable compared to the liquid absorber R (comparative example 1) that included none of the additives. Since permeability was high, no deposited matter remained either.

The amount of ink that was poured for both a dye ink and a pigment ink was changed in the example 2 and the comparative example 2, and the ink permeability, ink retention, and ink deposition were assessed. The results of assessment are as in table 2.

TABLE 2

| | Ink | Amount | Ink | Ink | Ink |
|---|---|---|---|---|---|
| | Type | Poured | Permeability | Retention | Deposition |
| Example 2 | Dye ink | 85 ml | OK | OK | OK |
| | Pigment ink | 80 ml | OK | OK | OK |
| Comparative | Dye ink | 80 ml | OK | OK | OK |
| Example 2 | Dye ink | 85 ml | NG | — | NG |
| | Pigment ink | 75 ml | OK | OK | OK |
| | Pigment ink | 80 ml | NG | — | NG |

As illustrated in table 2, the comparative example 2 (80 mL of dye ink) had OK ink permeability, ink retention, and ink deposition, but the comparative example 2 (85 mL of dye ink) was assessed as NG on all counts, include ink permeability. By contrast, the example 2 (85 mL of dye ink) was assessed as being excellent on all counts of ink permeability, ink retention, and ink deposition. This means that however less hydrophobic the cellulose fiber is and more readily the ink is retained, the poorer the permeability. Though ink permeated up to the amount of ink of the comparative example 2 (80 mL of dye ink), no further ink could be permeated, as in the comparative example 2 (85 mL of dye ink). When the ink was not poured from a single point but rather the ink was poured onto the entire surface, then the ink permeated into the entirety of the absorber, thus causing the assessment of retention to also become favorable. However, with an inkjet printer, it would not be possible to have a mechanism for pouring the ink onto the entire surface of the large absorber, and ink has been poured from a single point, circumstances which mean that usage with the circumstances of the comparative example 2 would not be possible. In the example 1, because the surface modified cellulose fiber was added, the liquid absorber I was more highly hydrophobic and the permeability to the ink was improved, believed to thus make it possible for even more of the ink to be permeated and possible also to maintain the retention performance. The comparative example 2 (75 mL of pigment ink) had OK ink permeability, ink retention, and ink deposition, but the comparative example 2 (80 mL) was assessed as being NG for all counts, including ink permeability. By contrast, the example 2 (80 mL of pigment ink) was assessed as being excellent on all counts. This signifies that in cases where the surface-modified cellulose fiber was not added, the highly hydrophobic pigment particles were less readily permeated, because the cellulose fiber is poorly hydrophobic. For this reason, pigment particles remained on the area of portion, and the repeated drying caused the pigment particles to be deposited. Permeability was NG, then, with an amount less than that of the dye ink. Even the comparative example 2 (75 mL of pigment ink) had some deposition of pigment particles, but was not so extreme as to have NG for permeability. When an amount of pigment ink was further added, the comparative example 2 (80 mL of pigment ink) reached NG. The example 2 (80 mL of pigment ink), however, had the added surface-modified cellulose fiber, and therefore the liquid absorber I was more highly hydrophobic and the affinity to the pigment particles was greater, thus improving the force of permeation to the ink, even with pigment ink, and reducing the amount of pigment particles that linger on the area of pouring, believed to make it possible for even more of the ink to be permeated and possible to maintain the retention performance.

The examples above were used as the liquid absorption tank 300 (300a) and the liquid absorber 200 (200a) in the inkjet printer 10 serving as an electrical machine. Herein, the ink, serving as the liquid, encompassed a variety of liquid compositions, such as general water-based ink, oil-based ink, pigment ink, dye ink, solvent-based ink, resin-based ink, sublimation transfer ink, gel ink, hot melt ink, and UV-curing ink. The ink can further be any material such that ejecting by the head 24 is possible. Provided that the state be one where the substance is in a liquid phase, examples would include fluids such as a liquid crystal, high- or low-viscosity liquid, sol, gel water, other inorganic solvent, organic solvent, solutions, liquid resin, or liquid metal (metal melt), and not only liquid as one state of matter, but also particles of functional materials composed of solid matter such as pigment or metal particles that have been dissolved, dispersed, or mixed into a solvent, as well as etchants and lubricants, and the like. Beyond the inkjet printer 10, the electrical machine can also be, for example, a device for ejecting ink containing a dispersed or dissolved form of a material such as a coloring or electrode material used to produce a liquid crystal display, electroluminescence (EL) display, surface emitting display, or color filter or the like; a device for ejecting a biological organic material used to produce biochips; a device for ejecting an ink to serve as a reagent used as a precision pipette; a printing device; a microdispenser; or the like. Additionally, the invention can be employed in a device for ejecting a lubricant in pinpoints onto a precision machine such as a timepiece or camera; a device for forming a micro hemispherical lens (an optical lens) used in an optical communication element or the like; a device for ejecting an ultraviolet ray-curable solution and curing with light or heat; or a device for ejecting an etchant such as an acid or alkali in order to etch a substrate or the like. The invention can be applied to any of these types of electrical machines. A liquid such as is not ejected, as a liquid droplet ejection device, can be absorbed. Examples could include liquids in general, such as water, oil, sewage, or urine.

In the examples described above, a thin-surfaced non-woven fabric can be affixed for such purposes as to prevent fuzzing of the surface of the liquid absorber 200 (200a). The non-woven fabric that is affixed is thinner than the liquid absorber 200 and therefore has little impact on the permeability to ink or the retention performance. In the examples described above, the liquid absorber 200 (200a) was a cuboid, but there is no limitation thereto. A cut-out or depression can be made in a part of the cuboid, or, instead of a cuboid, the shape can include an arcuate section or an inclined section. The second embodiment described above can be carried out in a similar manner also with 3-aminopropyl trimethoxysilane as the silane coupling agent.

In the examples described above, a “pulp sheet” encompasses: a wood pulp such as hardwood or softwood; a non-wood plant fiber such as hemp, cotton, or kenaf; waste paper; and the like. The examples described above were composed primarily of cellulose fiber, but there is no limitation to cellulose fiber provided that ink can be absorbed and that the difference in surface tension from the additive be apparent. The material can be a fiber for which the raw material is a plastic such as a polyurethane or polyethylene terephthalate (PET), or another fiber such as wool. The method for shaping the waste ink absorber is not limited to the methods as set forth in the examples described above. Any other method of production, such as a wet method, can be used, provided that the features of the present application are apparent.

1. A liquid absorber for absorbing a liquid being composed principally of a fiber, comprising
an additive that has a greater critical surface tension than the critical surface tension of the fiber.

2. The liquid absorber as set forth in claim 1, wherein
the additive has a greater critical surface tension than the surface tension of the liquid.

3. The liquid absorber as set forth in claim 1, wherein
the critical surface tension of the additive is 1.5-fold or more the critical surface tension of the fiber.

4. A liquid absorber for absorbing a liquid being composed principally of a cellulose fiber, comprising
an additive that is more highly hydrophobic than is the cellulose fiber.

5. The liquid absorber as set forth in claim 4, wherein
the liquid is waste ink that has been discharged from a head for electing ink.

6. The liquid absorber as set forth in claim 5, wherein
the ink is a pigment ink in which pigment particles are dispersed.

7. The liquid absorber as set forth in claim 4, wherein
the additive is a surface-modified cellulose fiber that has been surface-modified.

8. A liquid absorption tank, comprising
the liquid absorber as set forth in claim 1, and
a containing section for containing the liquid absorber.

9. An electrical machine, comprising:
a discharge section for discharging a liquid, and
the liquid absorption tank as set forth in claim 8 for capturing the discharged liquid.
